(19) United States
(12) Patent Application Publication
(10) Pub. No.: US 2025/0247824 A1
(43) Pub. Date: Jul. 31, 2025

(54) SYSTEMS AND METHODS FOR GROUPING PAGING FRAMES AND PAGING OCCASIONS AND ADAPTING SSB PERIODICITY

(71) Applicant: SAMSUNG ELECTRONICS CO., LTD., Suwon-si (KR)

(72) Inventors: Liang HU, San Diego, CA (US); Philippe Jean Marc Michel SARTORI, Naperville, IL (US)

(21) Appl. No.: 19/023,116

(22) Filed: Jan. 15, 2025

Related U.S. Application Data
(60) Provisional application No. 63/625,827, filed on Jan. 26, 2024.

(51) Int. Cl. H04W 68/02; H04W 56/00; H04W 68/00; H04W 72/1263; H04W 74/0833

(52) U.S. Cl. CPC H04W 68/02; H04W 56/001; H04W 68/005; H04W 72/1263; H04W 74/0833

(57) ABSTRACT

A method is disclosed for reducing power consumption during paging reception. The method includes identifying, by a UE, one paging frame of a plurality of paging frames or one paging occasion of a plurality of paging occasions in a paging frame, the plurality of paging frames being continuous in time instances in a beginning of a paging cycle, and the plurality of paging occasions being continuous in time instances in a beginning of the paging frame, and receiving, from a network node by the UE, a paging message in at least one paging frame of the plurality of paging frames or at least one paging occasion of the plurality of paging occasions. The plurality of paging frames includes a legacy paging frame and a non-legacy paging frame, and the plurality of paging occasions includes a legacy paging occasion and a non-legacy paging occasion.

### CROSS-REFERENCE TO RELATED APPLICATION

The present application claims priority to and the benefit under 35 U.S.C. § 119(e) of U.S. Provisional Application No. 63/625,827, filed on Jan. 26, 2024, entitled “PAGING ADAPTATION FOR NETWORK ENERGY SAVING,” the entire disclosure of which are incorporated by reference herein.

### BACKGROUND

### 1. Field

Aspects of some embodiments relate to wireless communications. For example, aspects of some embodiments of the present disclosure relate to improvements to paging reception procedure by grouping paging frames and paging occasions and utilizing adaptive Synchronization Signal Block (SSB) periodicity.

### 2. Description of the Related Art

There is a growing demand to reduce power consumption in the network due to the development of denser networks, larger operating bandwidths, and larger number of antennas being utilized. For example, when the network node (e.g., a gNB) performs paging within a paging cycle, the network node pages periodically via a radio frame within the paging cycle, which means that the network node awakes periodically even when the paged user equipment is not in the paging coverage area. Therefore, there is a need for a method to allow the network node to be in sleep mode as much as possible to save power in the network.

The above information disclosed in this Background section is only for enhancement of understanding of the background and therefore the information discussed in this Background section does not necessarily constitute prior art.

### SUMMARY

Modern communications equipment (e.g., mobile phones, vehicles, laptops, satellites, and the like), also known as UE, may communicate with a network node (e.g., a gNB) to receive data from a network associated with the network node and to transmit data to the network associated with the network node. The network node may perform paging periodically throughout a time interval, even when the UE is not in the cell coverage area, which becomes a major part of an operators' operating expense (OPEX). Furthermore, a method for adapting common signal in time domain Due to the deployment of cellular systems that is towards denser networks, larger operating bandwidths, and the use of large number of antennas, a need to reduce power consumption of cellular networks is desired.

According to some embodiments of the present disclosure, a method for grouping paging frames and/or paging occasions may include identifying, by a UE, one paging frame of a plurality of paging frames or one paging occasion of a plurality of paging occasions in a paging frame, the plurality of paging frames being continuous in time instances in a beginning of a paging cycle, and the plurality of paging occasions being continuous in time instances in a beginning of the paging frame, and receiving, from a network node by the UE, a paging message in at least one paging frame of the plurality of paging frames or at least one paging occasion of the plurality of paging occasions. The plurality of paging frames may include at least one legacy paging frame and at least one non-legacy paging frame, and the plurality of paging occasions may include at least one legacy paging occasion and at least one non-legacy paging occasion.

In one or more embodiments, the plurality of paging frames may be bundled in time domain, and the plurality of paging occasions is bundled in the time domain.

In one or more embodiments, the plurality of paging frames may be bundled in one or more consecutive frames within the paging cycle.

In one or more embodiments, the plurality of paging occasions may be bundled in a number of consecutive time slots within the paging frame.

In one or more embodiments, the one paging frame of the plurality of paging frames may be identified based on a UE identifier, a sum of a total number of the plurality of paging frames in the paging cycle, and a time domain offset of the paging cycle.

In one or more embodiments, a paging occasion index for the plurality of paging frames may be determined based on a UE identifier, a total number of paging occasions in the one paging frame of the plurality of paging frames, and a total number of the plurality of paging frames in the paging cycle.

In one or more embodiments, a paging occasion index for the plurality of paging occasions may be determined based on a UE identifier and a total number of the plurality of paging occasions in the paging frame.

In one or more embodiments, the UE may identify the one paging frame of the plurality of paging frames before identifying a plurality of paging occasions in the one paging frame of the plurality of paging frames.

According to some embodiments of the present disclosure, a method for adapting a SSB periodicity may include sending, to a network node by a UE, a Synchronization Signal Block (SSB) adaptation request indicating a SSB periodicity in a time interval, and receiving, from the network node by the UE, an acknowledge message in response to the SSB adaptation request.

In one or more embodiments, the method may further include receiving, from the network node by the UE, an indication message, the indication message comprising a physical random access channel (PRACH) preamble or a PRACH occasion for requesting the SSB periodicity, and mapping, by the UE, the PRACH preamble or the PRACH occasion to the SSB periodicity.

In one or more embodiments, the SSB adaptation request may be sent via message 1 or message 3.

In one or more embodiments, the SSB adaptation request may be sent utilizing 3 bits in uplink control information (UCI).

In one or more embodiments, the UE may be pre-configured with a set of potential SSB periodicities.

According to some embodiments of the present disclosure, a UE for grouping paging frames and/or paging occasions may include a processing circuit, the processing circuit being configured to perform identifying one paging frame of a plurality of paging frames or one paging occasion of a plurality of paging occasions in a paging frame, the plurality of paging frames being continuous in time instances in a beginning of a paging cycle, and the plurality of paging occasions being continuous in time instances in a beginning of the paging frame, and receiving, from a network node, a paging message in at least one paging frame of the plurality of paging frames or at least one paging occasion of the plurality of paging occasions. The plurality of paging frames may include at least one legacy paging frame and at least one non-legacy paging frame, and the plurality of paging occasions may include at least one legacy paging occasion and at least one non-legacy paging occasion.

### BRIEF DESCRIPTION OF THE DRAWINGS

The above and other aspects of the present disclosure will be more clearly understood from the following detailed description of the illustrative, non-limiting embodiments with reference to the accompanying drawings.

FIG. 1 is a schematic drawing of a network, according to some embodiment of the present disclosure.

FIG. 2 is a diagram depicting a method for grouping paging frames in a paging cycle, according to some embodiments of the present disclosure.

FIG. 3 is a diagram depicting a method for grouping paging occasions in a paging frame, according to some embodiments of the present disclosure.

FIG. 4 is a flowchart depicting a method for grouping paging frames and/or paging occasions, according to some embodiments of the present disclosure.

FIG. 5 is a diagram depicting a method for dynamically adapting SSB/SIB1 periodicity contention-free, according to some embodiments of the present disclosure.

FIG. 6 is a diagram depicting another method for dynamically adapting SSB/SIB1 periodicity contention-based, according to some embodiments of the present disclosure.

FIG. 7 is a flowchart depicting a method for grouping paging frames and/or paging occasions, according to some embodiments of the present disclosure.

FIG. 8 is a flowchart depicting a method for dynamically adapting SSB/SIB1 periodicity, according to some embodiments of the present disclosure.

FIG. 9 is a block diagram of an electronic device in a network environment, according to some embodiments of the present disclosure.

FIG. 10 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the terms “or” and “and/or” include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The electronic or electric devices and/or any other relevant devices or components according to embodiments of the present disclosure described herein may be implemented utilizing any suitable hardware, firmware (e.g., an application-specific integrated circuit (ASIC)), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Considering a growing development of denser networks, larger operating bandwidths, and a larger number of antennas being utilized, there are higher demands to reduce power consumption in transmissions between UEs and network nodes (e.g., gNBs) in the networks. For example, for the common signals that need to be transmitted during gNB's idle/inactive periods, single-sideband modulation (SSB), system information block (SIB), and physical random access channel (PRACH) transmissions may be adjusted to be as large as 160 millisecond (msec). Furthermore, paging periods may also be adjusted to happen at 160 msec. Furthermore, if (e.g., when) a paging period is relatively shorter (e.g., 160 milliseconds (msec)) which implies fewer paging opportunities and there is a large number of UEs that need to be simultaneously paged, there might not be sufficient paging occasions. Therefore, there is a need for a solution that may increase the time interval within paging opportunities (e.g., paging frames and paging occasions) while maintaining the paging channel capacity.

Based on the current paging procedures, the paging frames (PFs) and paging occasions (POs) are distributed evenly (regularly) across time (e.g., periodically occurring within a cycle), which may negatively impact network nodes (e.g., gNBs) being able to go to deep sleep mode as the network nodes might need to wake up to perform paging even when the paged UEs might not be in the cell coverage area. This is because the network does not know the location of UEs in idle or inactive mode within the paging tracking area, and all the cells within the paging tracking area need to broadcast paging regardless of whether there is a UE responding to the paging. For example, if a number of paging frames is configured to T/4, and a number of paging occasions is configured to 4, the network node may need to transmit paging every 4 radio frames.

Therefore, there is a need to enable the network node to perform the transmissions within continuous radio frames in a monitoring cycle instead of periodically paging multiple times within the cycle, such that the network node may be back to deep sleep mode as long as possible to save energy of the network.

To overcome these issues, systems and methods are described herein for grouping paging frames or paging occasions and adapting SSB periodicity. In legacy methods and systems, the paging frames are regularly distributed into a paging interval. In the systems and methods of the present disclosure, paging frames are grouped (allocated) at the beginning of the paging interval, with no other paging frames present in the rest of the paging interval. For example, the network nodes may only need to page during a specific time (e.g., grouped paging frames/grouped paging occasions) within a cycle (e.g., a DRX cycle), and then go back to sleep for the rest of the cycle to save energy. With the grouped paging frames, including identification of paging frames and paging occasions, a consumption of the network energy may be reduced or saved in time domain. In particular, the method for grouping paging frames and paging occasions retains the same paging transmission density by grouping the paging frames and paging occasions (e.g., the same number of the original paging frames that are evenly distributed in the time interval) to consecutive frames or slots, such that the network node does not necessarily need to wake up frequently. Furthermore, the network nodes may dynamically adapt a SSB periodicity, so that the network nodes may go into deep sleep mode as often as possible.

As described in more detail below, aspects of some embodiments of the present disclosure may enable saving energy in the network by grouping paging frames or paging occasions and/or dynamically adapting SSB periodicity. The above approaches may enable reducing the power consumption and overhead involved in the paging reception.

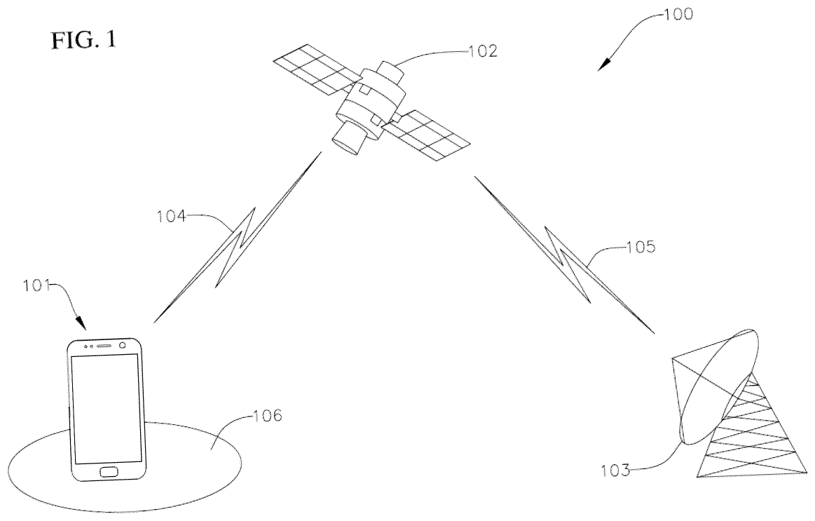

FIG. 1 is a schematic drawing of a network, according to some embodiment of the present disclosure. Network 100 may be a multiple access wireless communication system that supports a broadcast service, such as a non-terrestrial network (NTN). The network 100 may be designed to support one or more standards, such as 3rd Generation Partnership Project (3GPP). The network 100 may include a user equipment (UE) 101, a satellite 102, and a gateway 103.

The UE 101 may be able to transmit, receive, store, and process data. The UE 101 may be a transceiver system such as a mobile device, laptop, or other equipment. For example, the UE 101 may receive a paging message from the network 100 in idle or inactive mode within a paging cycle.

The satellite 102 may be a space borne or airborne platform capable of sending and receiving data from the UE 101 and the gateway 103. The satellite 102 may be in communication with the UE 101, where the satellite 102 may be able to transmit and receive data from the UE 101 over a service link 104. The service link 104 may include uplink (UL) and downlink (DL) data transmission.

The gateway 103 may be an antenna capable of sending and receiving data from the satellite 102. The gateway 103 may be connected to or associated with a base station or logical radio node, such as a gNodeB (gNB) base station, not shown. In one embodiment, actions performed by gNB, such as paging, scheduling, and coordination, may be referred to as being performed by the gateway 103, however, it may be understood that gNB may perform the command of sending data uplink or process receiving data downlink and the gateway 103 may transmit data for gNB and also receive data for gNB. For example, gNB may send a paging massage periodically to the UE 101 via a paging frame in a paging cycle. The gateway 103 may be in communication with the satellite 102 over a feeder link 105. The feeder link 105 may include UL and DL data transmission. In one embodiment, the UE 101, the satellite 102, and the gateway 103 may support a subcarrier spacing of 15, 30, 60, 120, or 240 KHz, however, other spacings may be supported.

A cell 106 may be a geographic area where the UE 101 and other UEs (not shown) are capable of communicating with the satellite 102. The size of the cell 106 may vary depending on the location of the satellite 102 relative to earth. For example, geostationary equatorial orbit (GEO) satellites may allow for a larger cell 106, which may be between 200 km to 3,500 km in diameter, in one embodiment. Medium earth orbit (MEO) and low earth orbit (LEO) may have smaller associated cell sizes. Furthermore, the distance of the satellite 102 to earth may affect the transmission time of transmitting and receiving data between the UE 101 and the satellite 102 and between the satellite 102 and the gateway 103. In one embodiment, a round trip delay (RTD) may be as high as 560 milliseconds (ms), 180 ms, and 60 ms for GEO, MEO, and LEO satellites systems, respectively. An RTD may be twice a propagation delay between the UE 101 and the gateway 103. The UE 101 may be capable of handling these RTDs with modifications of the timing aspects in the physical layer or higher layers of an Open Systems Interconnection (OSI) model, and a timing advance (TA) mechanism.

In operation, the UE 101 may send data to (UL) or receive data from (DL) data to satellite 102, which may send (UL) or receive (DL) data to the gateway 103, described in more detail below.

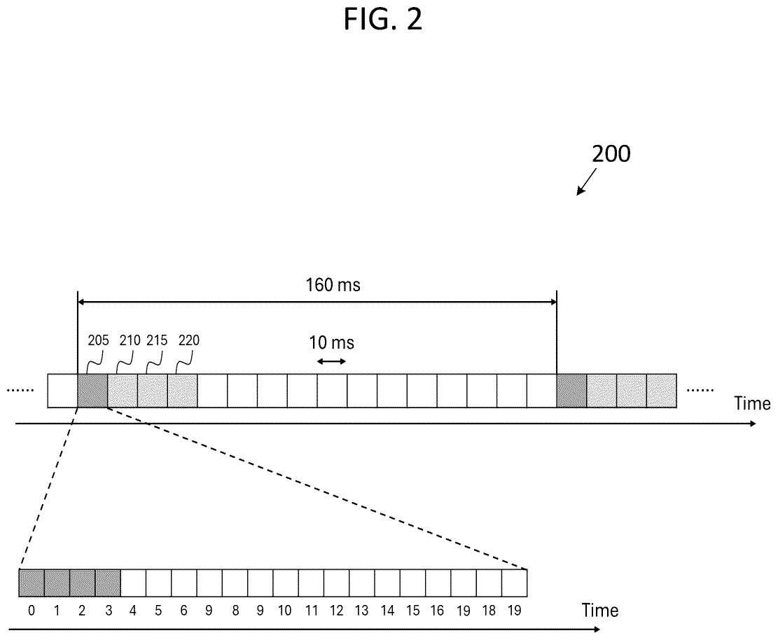

FIG. 2 is a diagram depicting a method for grouping paging frames in a paging cycle, according to some embodiments of the present disclosure.

Referring to FIG. 2, an example paging cycle 200 of the UE is depicted. In some embodiments, the paging cycle 200 may be a discontinuous reception (DRX) cycle. As shown in FIG. 2, the paging cycle includes 16 radio frames, and a duration of the paging cycle is 160 msec, which means that a duration of on radio frame is 10 msec. For saving power for both of the UE and the network, having a longer paging interval in the paging cycle 200 of the UE may be provided. In some embodiments, the paging cycle 200 may have a duration of 16 radio frames, and the UE checks for a paging message every 160 msec. In some embodiments, the paging cycle 200 may have a duration of 32 radio frames, and the UE checks for a paging message every 320 msec. As shown in FIG. 2, from a first paging frame n 205 to a fourth paging frame n+3 220 in the paging cycle 200, the UE may receive a paging message from the network (e.g., from a network node, such as a gNB) in idle or inactive mode. For example, the UE may check for paging reception from the first paging frame n to the fourth paging frame n+3. The UE may receive a paging message via at least one of the first paging frame n 205, the second paging frame n+1 210, the third paging frame n+2 215, and the fourth paging frame n+3 220. The first paging frame n 205, the second paging frame n+1 210, the third paging frame n+2 215, and the fourth paging frame n+3 220 may be continuously grouped together in the paging cycle 200. The grouped paging frames may enhance paging reception for the UE. For example, the grouped paging frames are allocated at the beginning of the paging cycle 200. Having more than one paging frame continuously may maintain a paging capacity. In addition, after the grouped paging frames, the network node may go to deep sleep mode to save energy.

In some embodiments, the number of grouped paging frames may be any appropriate number that is more than one. For example, if (e.g., when) there were four paging frames periodically distributed in a time interval (e.g., a DRX cycle), the number of grouped paging frames may be four. In some embodiments, the grouped paging frame (e.g., the first paging frame n 205 to a fourth paging frame n+3 220) may include an existing downlink (DL) paging frame.

In some embodiments, the first paging frame n 205 may be a legacy paging frame, and the second paging frame n+1_210, the third paging frame n+2 215, and the fourth paging frame n+3 220 may be newly-grouped paging frames.

In some embodiments, each paging frame (e.g., the first paging frame n 205, the second paging frame n+1_210, the third paging frame n+2 215, and the fourth paging frame n+3 220) may include one or more paging occasions. For example, the first paging frame n 205 may include 20 slots, and the first four slots (e.g., slot 0 to slot 3) among the 20 slots are paging occasions.

In some embodiments, the UE may identify its paging frame before identifying its paging occasions. Paging frames are defined by a system frame number (SFN), which may be calculated by an equation below:

$$( SFN mod T ) = ( UE\_id mod N ) + PF\_offset ,$$

where T is a discontinuous reception (DRX) cycle duration in the paging cycle, UE_id is 5G-S-TMSI mod 1024, N is a total number of the plurality of paging frames in the DRX cycle duration, and PF_offset is a time domain offset of the paging cycle 200.

In some embodiments, a paging occasion index may be calculated by an equation below:

$$i\_s = FLOOR ( UE\_id / N ) mod Ns ,$$

where Ns is a total number of paging occasions per paging frame, UE_id is 5G-S-TMSI mod 1024, and N is the total number of the plurality of paging frames in the DRX cycle duration. The paging occasion index may indicate which slots in the paging frame 205 are paging occasions.

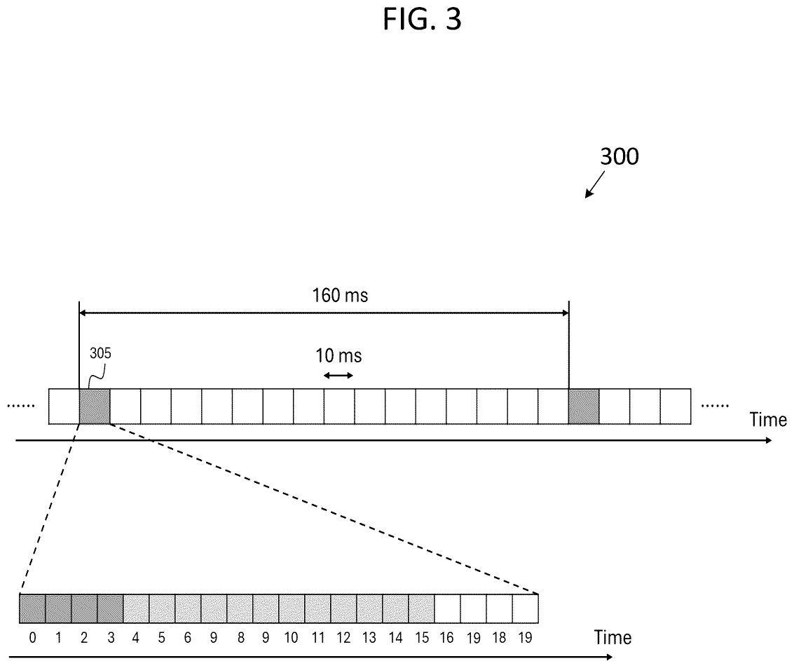

FIG. 3 is a diagram depicting a method for grouping paging occasions in a paging frame, according to some embodiments of the present disclosure.

Referring to FIG. 3, an example paging cycle 300 of the UE is depicted. In some embodiments, the paging cycle 300 may be a discontinuous reception (DRX) cycle. As shown in FIG. 3, the paging cycle includes 16 radio frames, and a duration of the paging cycle is 160 msec, which means that a duration of on radio frame is 10 msec. For saving power for both of the UE and the network, having a longer paging interval in the paging cycle 300 of the UE may be provided. In some embodiments, the paging cycle 300 may have a duration of 16 radio frames, and the UE checks for a paging message every 160 msec. In some embodiments, the paging cycle 300 may have a duration of 32 radio frames, and the UE checks for a paging message every 320 msec. As shown in FIG. 3, a first paging frame n 305 may include 20 slots, and the first sixteen slots (e.g., slot 0 to slot 15) are paging occasions. The UE may receive a paging message from the network (e.g., from a network node, such as a gNB) in idle or inactive mode via one of the paging occasions. For example, the UE may check for paging reception from slot 0 to slot 15. The UE may receive a paging message via at least one of slot 0 to slot 15. Slot 0 to slot 15 may be continuously grouped together in the paging frame 305.

In some embodiments, the number of grouped paging occasions may be any appropriate number that is more than one. In some embodiments, slot 0 to slot 3 may be legacy paging occasions, and slot 4 to slot 15 may be newly added paging occasions.

In some embodiments, the UE may identify its paging frame before identifying its paging occasions. In some embodiments, there may be only one paging frame 305 in the paging cycle 300. The paging frame is defined by a system frame number (SFN), which may be calculated by an equation below:

SFN=PF_offset,

where PF_offset is a time domain offset of the paging cycle.

In some embodiments, a paging occasion index may be calculated by an equation below:

$$i\_s = FLOOR ( UE\_id / N ) mod Ns ,$$

where Ns is a total number of paging occasions per paging frame, UE_id is 5G-S-TMSI mod 1024, and N is the total number of the plurality of paging frames in the DRX cycle duration. The paging occasion index may indicate which slots in the paging frame 305 are paging occasions.

Referring to FIG. 2 and FIG. 3, in some embodiments, additional paging occasions (e.g., slot 4 to slot 15), additional paging frames (e.g., the second paging frame n+1 210, the third paging frame n+2 215, and the fourth paging frame n+3 220), a group of paging occasions in a paging frame, and/or a paging frame in a group of paging frames respectively may only be allocated to the Rel-19 UEs, whereas legacy UEs may monitor paging occasions and/or paging frames according to a legacy procedure. In some embodiment, paging reception for the legacy UEs may be via the first paging frame n 205 of the paging cycle 200. In some embodiments, for the non-legacy UEs (e.g., the Rel-19 UEs), the paging reception (e.g., receiving a paging message) may be via the first paging frame n 205 or its following paging frames (e.g., the second paging frame n+1 210, the third paging frame n+2 215, and the fourth paging frame n+3 220).

In some embodiments, parameter required to calculate/identify the paging frames and paging occasions may be broadcast utilizing Physical Uplink Control Channel configuration (PUCCH-Config) parameters/configuration structure within System Information Block 1 (SIB1). To enable a paging adaptation (e.g., adapting grouped paging frames or grouped paging occasions), a new Information Element (IE) may be introduced into the PUCCH-Config: paging mode {0, 1, 2}, where “0” indicates a legacy paging procedure, “1” indicates a paging based on grouped paging frames, and “2” indicates a paging based on grouped paging occasions. In some embodiments, the Rel-19 UEs may read the new IE “paging-mode”, whereas the legacy UEs may not read the new IE and performs the legacy paging procedure. When utilizing the paging mode 1 (e.g., the grouped paging frames) or the paging mode 2 (e.g., the grouped paging occasions), the IE firstPDCCH-MonitoringOccasionOfPO may be taken into account the paging occasion and paging frame structures shown in FIG. 2 and FIG. 3. For example, new values of sCS15KHZoneT may be introduced in the IE firstPDCCH-MonitoringOccasionOfPO for the paging mode 1 and the paging mode 2.

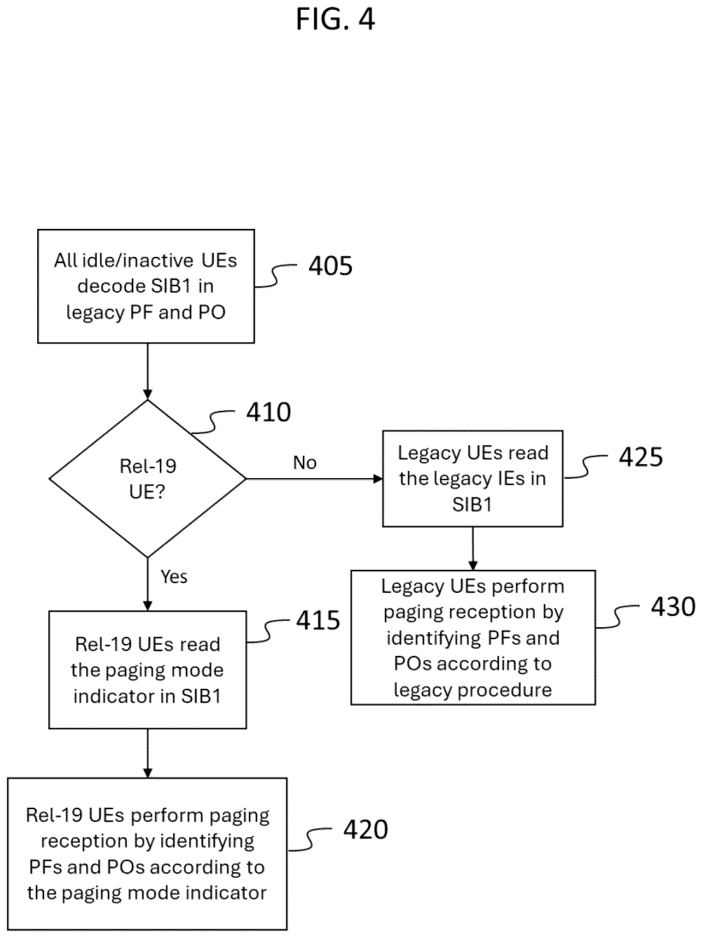

FIG. 4 is a flowchart depicting a method for grouping paging frames and/or paging occasions, according to some embodiments of the present disclosure. Although FIG. 4 illustrates various operations in a method for grouping paging frames and/or paging occasions, embodiments according to the present disclosure are not limited thereto, and according to one or more embodiments, the method may include additional operations or fewer operations, or the order of operations may vary, unless otherwise stated or implied, without departing from the spirit and scope of embodiments according to the present disclosure.

Referring to FIG. 4, at operation 405, UEs in idle or inactive mode may decode the SIB1 in a legacy paging frame (PF) and/or a legacy paging occasion (PO).

At operation 410, each UEs in idle or inactive mode may be determined whether the UEs are a Rel-19 UE or a legacy UE. If the UE is the Rel-19 UE, proceeding operation 415. If the UE is the legacy UE, proceeding with operation 420.

At operation 415, the Rel-19 UEs may read a paging mode indicator in the SIB1. For example, the paging mode indicator may indicate paging mode 0 (e.g., a legacy paging procedure), paging mode 1 (e.g., grouped paging frames), or paging mode 2 (e.g., grouped paging occasions).

At operation 420, the Rel-19 UEs may perform a paging reception utilizing identified paging frames and/or paging occasions according to the paging mode indicator.

At operation 425, the legacy UEs may read legacy IEs in the SIB1.

At operation 430, the legacy UEs may perform the paging reception utilizing identified paging frames and/or paging occasions according to legacy paging procedure.

In some embodiments, both grouped paging frames and grouped paging occasions may change the legacy SSB periodicity definition. For example, in paging mode 1 (e.g., grouped paging frames), one SSB periodicity of 160 ms may be shared between the Rel-19 UEs and the legacy UEs, where the SSB repetition in consecutive slots may be applicable only for the Rel-19 UEs. The Rel-19 UE may skip some of the SSB detections in the SSB repetition for synchronization, radio resource measurement (RRM), radio link monitoring (RLM), beam management (BM) procedure, and an initial access, to order to save power consumption of the Rel-19 UE. Alternatively, a network node (e.g., a gNB) may skip transmissions of SSB repetitions in consecutive paging frames (e.g., grouped paging frames) and/or consecutive paging occasions (e.g., grouped paging occasions), since one SSB may be enough in consecutive paging frames and/or paging occasions in terms of paging reception.

In some embodiments, a set of SSBs may be skipped by a UE, and a network node in a SSB repetition may be pre-defined and associated to a specific paging mode indicator.

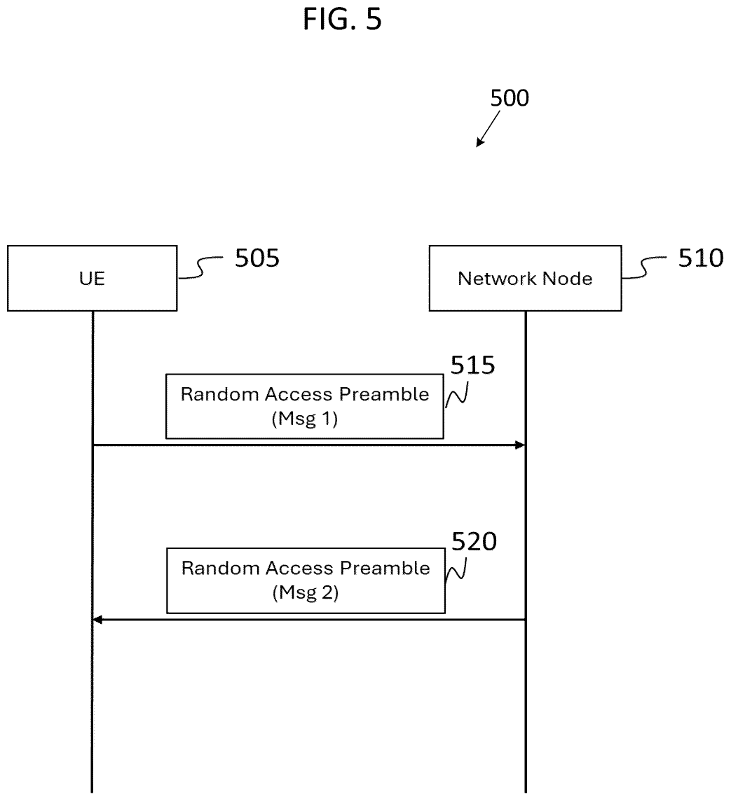

FIG. 5 is a diagram depicting a method for dynamically adapting SSB/SIB1 periodicity contention-free, according to some embodiments of the present disclosure. Although FIG. 5 illustrates various operations in a method for dynamically adapting SSB/SIB1 periodicity contention-free, embodiments according to the present disclosure are not limited thereto, and according to one or more embodiments, the method may include additional operations or fewer operations, or the order of operations may vary, unless otherwise stated or implied, without departing from the spirit and scope of embodiments according to the present disclosure.

Referring to FIG. 5, a method 500 for dynamically adapting SSB/SIB1 periodicity contention-free may include one or more of the following operations. The UE 505 may send a random access preamble (Msg1) (operation 515) to a network node 510 (e.g., a gNB (a 5G Node B or a base station)). In some embodiments, the UE 505 may receive a random access preamble (Msg2) (operation 520) from the network node 510. For example, the network node 510 may allocate a specific set of physical random access channel (PRACH) preambles and/or PRACH occasions for requesting a SSB adaptation, where a separate preamble and/or a PRACH occasion may be allocated for a specific SSB periodicity. The allocated random access preamble (Msg1) allows the UE 505 to request a specific, individual SSB periodicity with each preamble and/or PRACH occasion transmission. If (e.g., when) utilizing Msg1 to request a specific SSB periodicity, the network node 510 acknowledges the request in Msg1 at the Medium Access Control (MAC) layer via a Msg2 transmission. In some embodiments, the method 500 may be contention-free when the UE 505 requests the specific SSB periodicity utilizing Msg 1.

The method 500 is to adapt a specific SSB/SIB1 periodicity dynamically when certain conditions are met to allow the network node 510 go to deep sleep mode for saving network energy. For example, such conditions may be that the UEs in a cell may be tolerant of a long delay to perform an initial access procedure, a Radio Link Monitoring (RLM) procedure, a radio resource management (RRM) procedure, and/or a beam management (BM) procedure. In some embodiments, when certain conditions are not met, the network node 510 (e.g., a base station) may reduce the SSB/SIB periodicity (e.g., a shorter periodicity) to accommodate the UEs with strict latency requirements of performing the initial access procedure, the Radio Link Monitoring (RLM) procedure, the radio resource management (RRM) procedure, and/or the beam management (BM) procedure. In some embodiments, the method 500 for dynamically adapting SSB/SIB1 periodicity contention-free may be applicable to Rel-19 UEs.

In some embodiments, for the Rel-19 UEs, when applying the reduced SSB/SIB1 periodicity (e.g., a shorter periodicity), the Rel-19 UEs may adjust their implementation behavior accordingly and access the network with an increased SSB/SIB1 periodicity (e.g., a longer periodicity). If (e.g., when) the SSB/SIB1 periodicity may be dynamically or semi-statically indicated to the Rel-19 UEs, unnecessary blind decoding may be avoided or reduced, and the network node (e.g., a gNB) may dynamically change the SSB/SIB1 periodicity via a SIBx RRC message for the Rel-19 UEs in idle or inactive mode or via a downlink (DL) downlink control information (DCL) for connected Rel-19 UEs.

In some embodiments, the UEs may be pre-configured with a set of potential SSB/SIB1 periodicities via an initial SIB1 acquisition. An example of Information Element (IE) extended in SIB1 may be shown as below:

| | |
|---|---|
| ssb-PeriodicityServingCell | ENUMERATED {ms5, ms10, ms20, |
| | ms40, ms80, ms160} |

The connected UEs may be indicated by a serving gNB (e.g., the gNB that the UE is connected to) via group common DCI of which SSB/SIB1 periodicity is applied. For example, the group common DCI includes 3 bits to indicate which SSB/SIB1 periodicity is applied. The UEs in idle or inactive mode may be indicated by the serving gNB via a SIBx RRC message which SSB/SIB1 periodicity is applied.

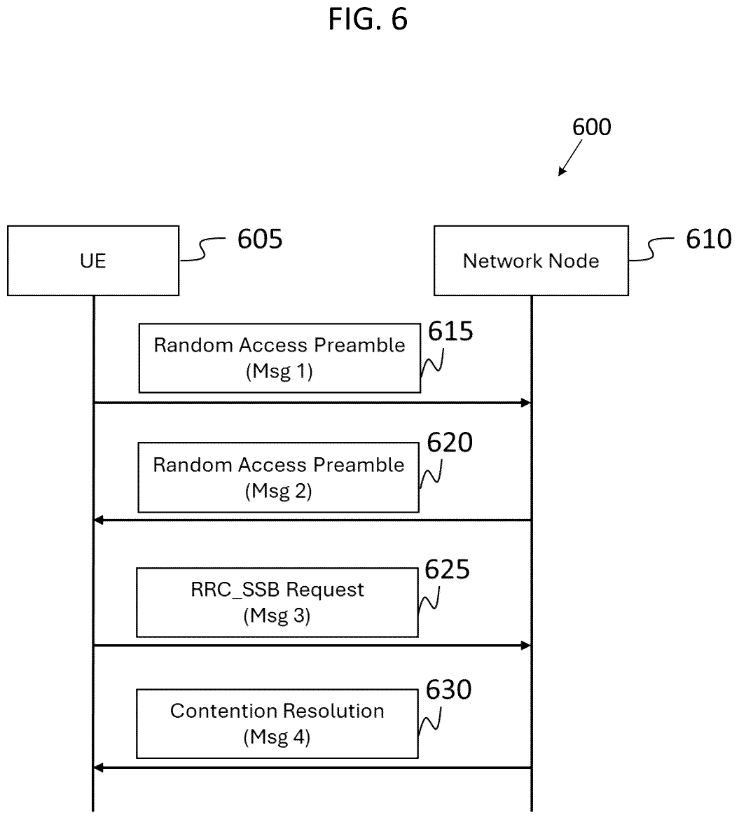

FIG. 6 is a diagram depicting a method for dynamically adapting SSB/SIB1 periodicity contention-based, according to some embodiments of the present disclosure. Although FIG. 6 illustrates various operations in a method for dynamically adapting SSB/SIB1 periodicity contention-based, embodiments according to the present disclosure are not limited thereto, and according to one or more embodiments, the method may include additional operations or fewer operations, or the order of operations may vary, unless otherwise stated or implied, without departing from the spirit and scope of embodiments according to the present disclosure.

Referring to FIG. 6, a method 600 for dynamically adapting SSB/SIB1 periodicity contention-based may include one or more of the following operations. The UE 605 may send a random access preamble (Msg1) (operation 615) to a network node 610 (e.g., a gNB (a 5G Node B or a base station)). In some embodiments, the UE 605 may send Msg 1 via physical random access channel (PRACH). In some embodiments, the UE 605 may receive a random access preamble (Msg2) (operation 620) from the network node 610. For example, the UE 605 may receive a Random Access Response (RAR) (Msg2) in response to Response Transmission (Msg1). In some embodiments, the UE 605 may send an RRC_SSB_Request (Msg3) (operation 625) to the network node 610. For example, the UE 605 completes a normal contention based random access procedure, and populates a Msg3 with a new RRC message, e.g., the RRC_SSB_Request message. The RRC_SSB_Request message may include a bit string, in which each bit in the bit string is linked to a specific SSB periodicity, which allows the UE 605 to request a specific SIB transmission by setting a specific bit to “1”. In some embodiments, the method 600 may be contention-based when the UE 605 requests the specific SSB periodicity utilizing Msg 3.

In some embodiments, an example RRC_SSB_Request message may be shown as Table 1 below:

TABLE 1
RRC_SSB_Request message

| | |
|---|---|
| Request-SSB-List | BIT STRING {32 bits} |
| Spare | BIT STRING {12 bits} |

In some embodiments, the UE 605 may receive a Contention Resolution message (Msg4) (operation 630) from the network node 610. Adapting a SSB periodicity dynamically may impact the Random-Access Channel (RACH) occasion, paging occasion, Radio Link Monitoring (RLM) configurations, beam management (BM) configurations, and/or radio resource management (RRM) configurations. To prevent or reduce such impacts happened, two approaches may be provided: (1) dynamically adapting the RACH occasion, paging occasion, RLM configurations, BM configurations, and/or RRM configurations for a new SSB periodicity via downlink control information (DCI)/Medium Access Control (MAC) control element (CE), and (2) utilizing a legacy procedure to update the RACH occasion, paging occasion, RLM, BM, and/or RRM configurations for the new SSB periodicity (e.g., SIB1/SIBx updating the UEs on new configurations). In some embodiments, dynamically adapting the new SSB periodicity may include a pre-defined table shown as Table 2 for configuring UEs, and each entry in the pre-defined table is a mapping:

TABLE 2

| | | | | | |
|---|---|---|---|---|---|
| Preamble 1/ | SSB periodicity | Paging | RACH | SMTC config. 1 | SIBx config. 1 |
| RACH | 1 | occasion | occasion | for RRM | |
| occasion 1 | | config. 1 | config. 1 for | | |
| | | | initial access | | |
| Preamble 2/ | SSB periodicity | Paging | RACH | SMTC config. 2 | SIBx config. 2 |
| RACH | 2 | occasion | occasion | for RRM | |
| occasion 2 | | config. 2 | config. 2 for | | |
| | | | initial access | | |
| Preamble 3/ | SSB periodicity | Paging | RACH | SMTC config. 3 | SIBx config. 3 |
| RACH | 3 | occasion | occasion | for RRM | |
| occasion 3 | | config. 3 | config. 3 for | | |
| | | | initial access | | |

In some embodiments, the entries in Table 2 may be pre-configured to the UEs.

Via a pre-configured mapping and dynamically indicating the SSB periodicity only, there is no need to dynamically indicate all other configurations (e.g., initial access configurations, paging configurations, RLM configurations, BM configurations, RRM configurations) via DCI, which may lead to a huge overhead in networking. In some embodiments, the method 600 for dynamically adapting SSB/SIB1 periodicity contention-based may be applicable to Rel-19 UEs.

In some embodiments, for certain Rel-19 UEs that have strict initial access latency requirements, the method 600 for such UEs to trigger an SSB/SIB1 transmission is provided to prevent or reduce the impact to the user experience.

In some embodiments, the UEs may be pre-configured with a set of potential SSB/SIB1 periodicities via an initial SIB1 acquisition. An example of IE extended in SIB1 may be shown as below:

| | |
|---|---|
| ssb-PeriodicityServingCell | ENUMERATED {ms5, ms10, ms20, |
| | ms40, ms80, ms160} |

The connected UEs request a change of the SSB/SIB1 periodicity to the network node via an uplink (UL) specific signal. For the connected UE, the UL signal may be based on the PRACH, Scheduling Request (SR), or specific uplink control information (UCI). In some embodiments, for PRACH-based UL signal, certain specific preambles may be mapped to a set of potential SSB/SIB1 periodicities, such that the UEs may indicate the network node (e.g., a gNB) which SSB/SIB1 periodicity that the UEs ask for. In some embodiments, for UCI-based UL signal, 3 bits in UCI may be utilized to indicate the network node which SSB/SIB1 periodicity that the UEs ask for.

In some embodiments, the UEs in idle or inactive mode request a change of the SSB/SIB1 periodicity to the network node (e.g., a gNB) via PRACH-based signal only. In some embodiments, the method 600 for the connected UEs may be applicable to UEs in idle or inactive mode.

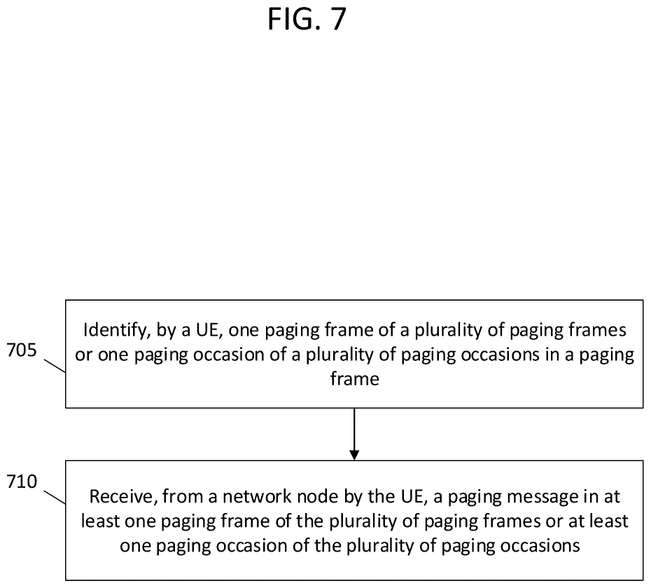

FIG. 7 is a flowchart depicting a method for grouping paging frames and/or paging occasions, according to some embodiments of the present disclosure. Although FIG. 7 illustrates various operations in a method for grouping paging frames and/or paging occasions, embodiments according to the present disclosure are not limited thereto, and according to one or more embodiments, the method may include additional operations or fewer operations, or the order of operations may vary, unless otherwise stated or implied, without departing from the spirit and scope of embodiments according to the present disclosure.

Referring to FIG. 7, at operation 705, a UE identifies one paging frame of a plurality of paging frames or one paging occasion of a plurality of paging occasions in a paging frame. In some embodiments, the plurality of paging frames may be continuous in time instances in a beginning of a paging cycle, and the plurality of paging occasions may be continuous in time instances in a beginning of the paging frame. For example, a first paging frame of the plurality of paging frames is adjacent to a second paging frame of the plurality of paging frames, and a first paging occasion of the plurality of paging occasions is adjacent to a second paging occasion of the plurality of paging occasions. That is, the plurality of paging frames being continuous means that that the plurality of paging frames is on consecutive frames, and the plurality of paging occasions being continuous means that the plurality of paging occasions is on consecutive subframes/slots.

In some embodiments, the plurality of paging frames may include at least one legacy paging frame and at least one non-legacy paging frame, and the plurality of paging occasions may include at least one legacy paging occasion and at least one non-legacy paging occasion. For example, the plurality of paging frames includes both of legacy paging frames and non-legacy paging frames (e.g., Rel-19 paging frames), so that the legacy paging frames may be utilized by legacy UEs and the non-legacy paging frames may be utilized by new UEs (e.g., Rel-19 UEs).

In some embodiments, the plurality of paging frames may be in the first half of the paging cycle. For example, if (e.g., when) the paging cycle includes 16 radio frames, the plurality of the paging frames may be the first four frames in the paging cycle. In some embodiments, the plurality of paging occasions may be in the first half of slots in the paging frame. For example, if (e.g., when) the paging frame has 20 slots, the plurality of paging occasions may be the first sixteen slots of the paging frame.

In some embodiments, the plurality of paging frames may be bundled in time domain, and the plurality of paging occasions is bundled in the time domain.

In some embodiments, the plurality of paging frames may be bundled in one or more consecutive frames within the paging cycle.

In some embodiments, the plurality of paging occasions may be bundled in a number of consecutive time slots within the paging frame.

In some embodiments, the UE may identify the one paging frame of the plurality of paging frames before identifying a plurality of paging occasions in the one paging frame of the plurality of paging frames.

At operation 710, the UE receives, from a network node, a paging message in at least one paging frame of the plurality of paging frames or at least one paging occasion of the plurality of paging occasions. In some embodiments, the UE may be in idle or inactive mode. In some embodiments, the network node may be a base station (e.g., a gNB).

In some embodiments, the one paging frame of the plurality of paging frames may be identified based on a UE identifier, a sum of a total number of the plurality of paging frames in the paging cycle, and a time domain offset of the paging cycle. In particular, the UE may identify the one paging frame of the plurality of paging frames based on a system frame number (SFN). The SFN may be determined or calculated by:

$$( SFN mod T ) = ( UE\_id mod N ) + PF\_offset ,$$

where T is a discontinuous reception (DRX) cycle duration in the paging cycle, UE_id is a UE identifier generated based on 5G-S-TMSI mod 1024, N is a total number of the plurality of paging frames in the DRX cycle duration, and PF_offset is the time domain offset of the paging cycle. In some embodiments, 5G-S-TMSI mod 1024 may refer to a formula/calculation used to generate a unique identifier for the UE by taking the modulo 1024 of its 5G-S-TMSI (5G-Temporary Mobile Subscriber Identity).

In some embodiments, a paging occasion index for the plurality of paging frames may be determined based on a UE identifier, a total number of paging occasions in the one paging frame of the plurality of paging frames, and a total number of the plurality of paging frames in the paging cycle. In particular, the paging occasion index for the plurality of paging frames may be determined by:

i_s=FLOOR(UE_id)mod Ns,
where UE_id is a UE identifier generated based on 5G-S-TMSI 1024, and Ns is a total number of paging occasions per paging frame.

In some embodiments, the paging frame may be identified based on a time domain offset of the paging cycle. In particular, the UE may identify the paging frame based on the SFN. The SFN may be determined or calculated by:

SFN=PF_offset,
where PF_offset is a time domain offset of the paging cycle.

In some embodiments, a paging occasion index for the plurality of paging occasions may be determined based on a UE identifier and a total number of the plurality of paging occasions in the paging frame. In particular, the paging occasion index of the paging frame may be determined or calculated by:

i_s=UE_id mod Ns,
where UE_id is a UE identifier generated based on 5G-S-TMSI mod 102, and Ns is a total number of paging occasions per paging frame. For example, the paging occasion index may indicate which slots in the paging frame are paging occasions.

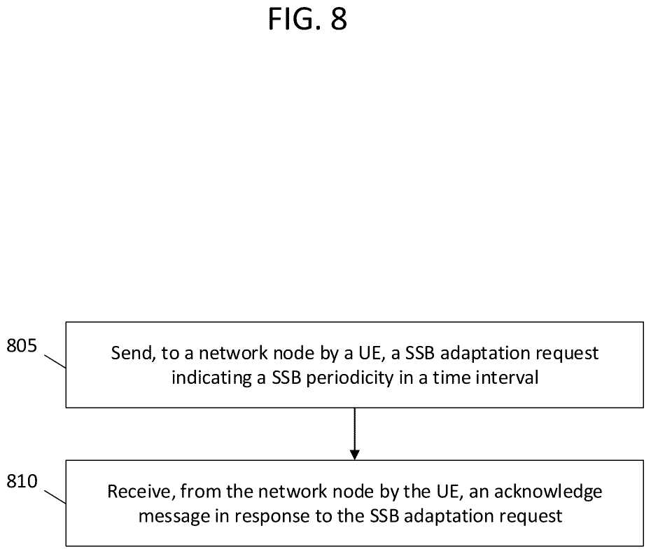

FIG. 8 is a flowchart depicting aspects of a method for dynamically adapting SSB/SIB1 periodicity, according to some embodiments of the present disclosure. Although FIG. 8 illustrates various operations in a method for dynamically adapting SSB/SIB1 periodicity, embodiments according to the present disclosure are not limited thereto, and according to one or more embodiments, the method may include additional operations or fewer operations, or the order of operations may vary, unless otherwise stated or implied, without departing from the spirit and scope of embodiments according to the present disclosure.

Referring to FIG. 8, at operation 805, a UE sends, to a network node, a SSB adaptation request indicating a SSB periodicity in a time interval. In some embodiments, the network node may be a base station (e.g., a gNB). In some embodiments, the SSB adaptation request may be sent via message 1 or message 3. In some embodiments, the SSB adaptation request may be sent utilizing 3 bits in uplink control information (UCI).

At operation 810, the UE receives, from the network node, an acknowledge message in response to the SSB adaptation request.

In some embodiments, the UE may further receive, from the network node, an indication message, the indication message comprising a PRACH preamble or a PRACH occasion for requesting the SSB periodicity. Furthermore, the UE may map the PRACH preamble or the PRACH occasion to the SSB periodicity.

In some embodiments, the UE may be pre-configured with a set of potential SSB periodicities.

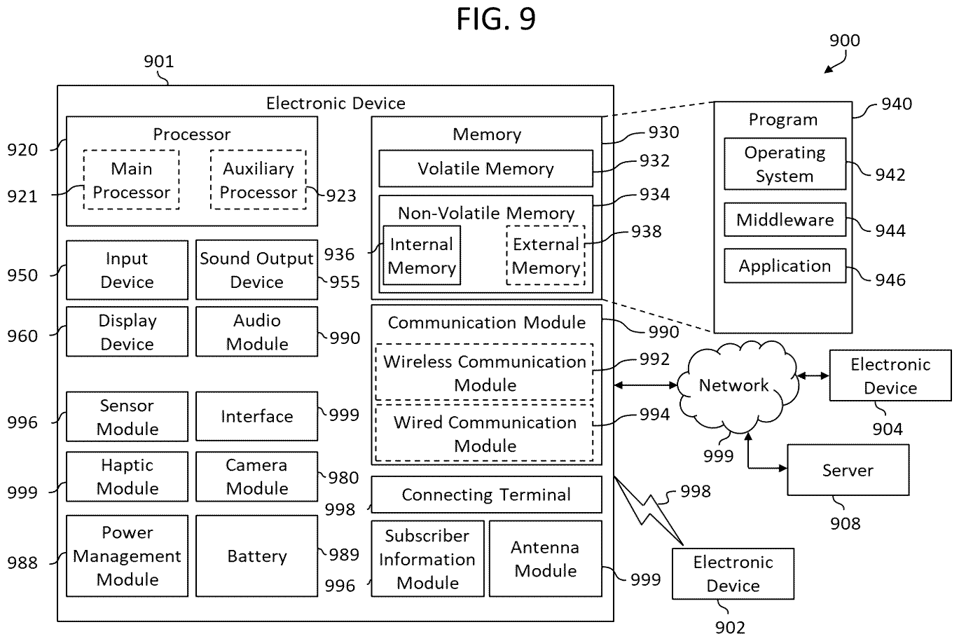

FIG. 9 is a block diagram of an electronic device in a network environment, according to some embodiments of the present disclosure.

Referring to FIG. 9, an electronic device 901 in a network environment 900 may communicate with an electronic device 902 via a first network 998 (e.g., a short-range wireless communication network), or with an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, and/or an antenna module 997. In one embodiment, at least one of the components (e.g., the display device 960 or the camera module 980) may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled to the processor 920, and may perform various data processing or computations.

As at least part of the data processing or computations, the processor 920 may load a command or data received from another component (e.g., the sensor module 976 or the communication module 990) in volatile memory 932, may process the command or the data stored in the volatile memory 932, and may store resulting data in non-volatile memory 934. The processor 920 may include a main processor 921 (e.g., a central processing unit or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or to execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990), as opposed to the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as separate from, or as a part of, the speaker.

The display device 960 may visually provide information to the outside (e.g., to a user) of the electronic device 901. The display device 960 may include, for example, a display, a hologram device, or a projector, and may include control circuitry to control a corresponding one of the display, hologram device, and projector. The display device 960 may include touch circuitry adapted to detect a touch, or may include sensor circuitry (e.g., a pressure sensor) adapted to measure the intensity of force incurred by the touch.

The audio module 970 may convert a sound into an electrical signal and vice versa. The audio module 970 may obtain the sound via the input device 950 or may output the sound via the sound output device 955 or a headphone of an external electronic device 902 directly (e.g., wired) or wirelessly coupled to the electronic device 901.

The sensor module 976 may detect an operational state (e.g., power or temperature) of the electronic device 901, or an environmental state (e.g., a state of a user) external to the electronic device 901. The sensor module 976 may then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 977 may support one or more specified protocols to be used for the electronic device 901 to be coupled to the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected to the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus, which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power that is supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell that is not rechargeable, a secondary cell that is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908), and may support performing communication via the established communication channel. The communication module 990 may include one or more communication processors that are operable independently from the processor 920 (e.g., the AP), and may support a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH™, wireless-fidelity (Wi-Fi) direct, or a standard of the Infrared Data Association (IrDA)), or via the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas. The communication module 990 (e.g., the wireless communication module 992) may select at least one of the one or more antennas appropriate for a communication scheme used in the communication network, such as the first network 998 or the second network 999. The signal or the power may then be transmitted or received between the communication module 990 and the external electronic device via the selected at least one antenna.

Commands or data may be transmitted or received between the electronic device 901 and the external electronic device 904 via the server 908 coupled to the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, cloud computing, distributed computing, or client-server computing technology may be used, for example.

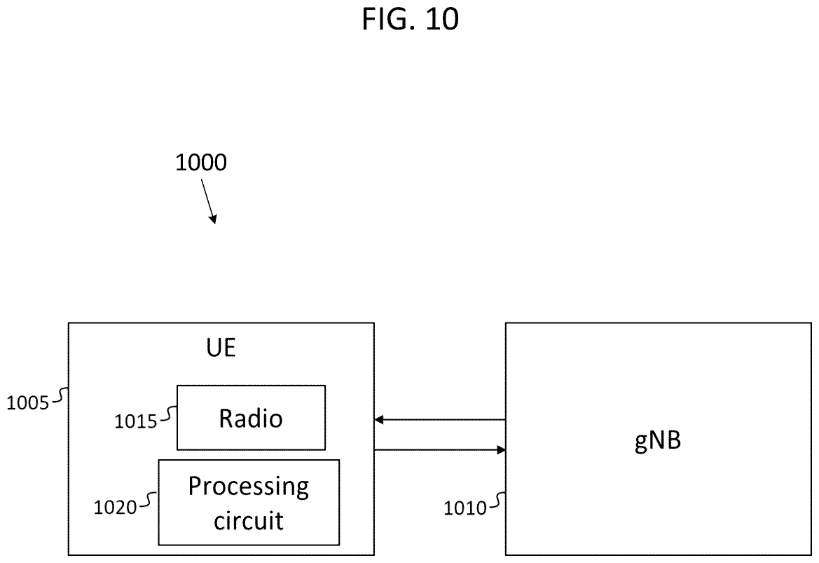

FIG. 10 shows a system including a UE 1005 and a gNB 1010, in communication with each other. The UE may include a radio 1015 and a processing circuit (or a means for processing) 1020, which may perform various methods disclosed herein, e.g., the method illustrated in FIG. 9. For example, the processing circuit 1020 may receive, via the radio 1015, transmissions from the network node (gNB) 1010, and the processing circuit 1020 may transmit, via the radio 1015, signals to the gNB 1010.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims, with functional equivalents thereof to be included therein.

What is claimed is:

1. A method comprising:
identifying, by a user equipment (UE), one paging frame of a plurality of paging frames or one paging occasion of a plurality of paging occasions in a paging frame, the plurality of paging frames being continuous in time instances in a beginning of a paging cycle, and the plurality of paging occasions being continuous in time instances in a beginning of the paging frame; and
receiving, from a network node by the UE, a paging message in at least one paging frame of the plurality of paging frames or at least one paging occasion of the plurality of paging occasions,
wherein the plurality of paging frames comprises at least one legacy paging frame and at least one non-legacy paging frame, and the plurality of paging occasions comprises at least one legacy paging occasion and at least one non-legacy paging occasion.

2. The method of claim 1, wherein the plurality of paging frames is bundled in time domain, and the plurality of paging occasions is bundled in the time domain.

3. The method of claim 1, wherein the plurality of paging frames is bundled in one or more consecutive frames within the paging cycle.

4. The method of claim 1, wherein the plurality of paging occasions is bundled in a number of consecutive time slots within the paging frame.

5. The method of claim 1, wherein the one paging frame of the plurality of paging frames is identified based on a UE identifier, a sum of a total number of the plurality of paging frames in the paging cycle, and a time domain offset of the paging cycle.

6. The method of claim 1, wherein a paging occasion index for the plurality of paging frames is determined based on a UE identifier, a total number of paging occasions in the one paging frame of the plurality of paging frames, and a total number of the plurality of paging frames in the paging cycle.

7. The method of claim 1, wherein a paging occasion index for the plurality of paging occasions is determined based on a UE identifier and a total number of the plurality of paging occasions in the paging frame.

8. The method of claim 1, wherein the UE identifies the one paging frame of the plurality of paging frames before identifying a plurality of paging occasions in the one paging frame of the plurality of paging frames.

9. A method comprising:
sending, to a network node by a UE, a Synchronization Signal Block (SSB) adaptation request indicating a SSB periodicity in a time interval; and
receiving, from the network node by the UE, an acknowledge message in response to the SSB adaptation request.

10. The method of claim 9, further comprising:
receiving, from the network node by the UE, an indication message, the indication message comprising a physical random access channel (PRACH) preamble or a PRACH occasion for requesting the SSB periodicity, and
mapping, by the UE, the PRACH preamble or the PRACH occasion to the SSB periodicity.

11. The method of claim 9, wherein the SSB adaptation request is sent via message 1 or message 3.

12. The method of claim 9, wherein the SSB adaptation request is sent utilizing 3 bits in uplink control information (UCI).

13. The method of claim 9, wherein the UE is pre-configured with a set of potential SSB periodicities.

14. A user equipment (UE) comprising a processing circuit, the processing circuit being configured to perform:
identifying one paging frame of a plurality of paging frames or one paging occasion of a plurality of paging occasions in a paging frame, the plurality of paging frames being continuous in time instances in a beginning of a paging cycle, and the plurality of paging occasions being continuous in time instances in a beginning of the paging frame; and
receiving, from a network node, a paging message in at least one paging frame of the plurality of paging frames or at least one paging occasion of the plurality of paging occasions,
wherein the plurality of paging frames comprises at least one legacy paging frame and at least one non-legacy paging frame, and the plurality of paging occasions comprises at least one legacy paging occasion and at least one non-legacy paging occasion.

15. The UE of claim 14, wherein the plurality of paging frames is bundled in time domain, and the plurality of paging occasions is bundled in the time domain.

16. The UE of claim 14, wherein the plurality of paging frames is bundled in one or more consecutive frames within the paging cycle.

17. The UE of claim 14, wherein the plurality of paging occasions is bundled in a number of consecutive time slots within the paging frame.

18. The UE of claim 14, wherein the one paging frame of the plurality of paging frames is identified based on a UE identifier, a sum of a total number of the plurality of paging frames in the paging cycle, and a time domain offset of the paging cycle.

19. The UE of claim 14, wherein a paging occasion index for the plurality of paging frames is determined based on a UE identifier, a total number of paging occasions in the one paging frame of the plurality of paging frames, and a total number of the plurality of paging frames in the paging cycle.

20. The UE of claim 19, wherein a paging occasion index for the plurality of paging occasions is determined based on a UE identifier and a total number of the plurality of paging occasions in the paging frame.
